(19) United States
(12) Patent Application Publication
(10) Pub. No.: US 2007/0055188 A1
(43) Pub. Date: Mar. 8, 2007

(54) Supportive structure and circulation enhancing apparatus

(75) Inventors: Yuval Avni, Givatayim (IL); Benny Rousso, Rishon Lezion (IL)

Correspondence Address: HOGAN & HARTSON LLP;IP GROUP, COLUMBIA SQUARE, 555 THIRTEENTH STREET, N.W., WASHINGTON, DC, 20004, US

(73) Assignee: Flowmedic Limited

(21) Appl. No.: 11/442,647

(22) Filed: May 30, 2006

Related U.S. Application Data
(63) Continuation-in-part of application No. PCT/IL03/01016, filed on Nov. 30, 2003.

(51) Int. Cl. A61H 7/00

(52) U.S. Cl. 601/151; 601/148; 602/13; 601/DIG. 20

(57) ABSTRACT

An apparatus for supporting a body part and for facilitating enhanced circulation therein comprising a rigid supportive structure configured for encasing at least partially said body part and a compression unit mounted on said supportive structure adapted for actuating intermittent compression of said body part.

### RELATED APPLICATIONS

This application is a continuation-in-part of PCT patent application serial number PCT/IL2003/001016 titled A METHOD AND APPARATUS FOR ENHANCEMENT OF CIRCULATION WITHIN CAST ENCASED BODY. PART filed on 30 Nov. 2003, the full content of which is incorporated herein by reference.

### FIELD OF THE INVENTION

The present invention generally relates to enhancement of circulation in general, and to an apparatus for supporting a body part and for facilitating enhanced circulation therewithin, in particular.

### DISCUSSION OF THE RELATED ART

A cast refers to a supportive structure that keeps an injured body part from moving, thus allowing it to heal. Persons having a body part put in a cast typically suffer from discomfort, swelling, pain, redness and irritation of the skin, blood clot, compartment compression syndrome and the like. These conditions result from static position of the body part put in the cast. Stasis is believed to trigger disorders such as the formation of blood clots which result in other complications, including arterial and pulmonary embolism, deep vein thrombosis (DVT) renal vein thrombosis, thrombophlebitis, angina, ischemia, coronary artery disease, stroke and heart disease.

A compartment syndrome involves the compression of nerves and blood vessels within an enclosed space, such as in a cast. The compartment syndrome may lead to impaired blood flow and nerve damage. Increased pressure in compartments within the fascia leads to increased pressure within the compartments. High pressure within the compartments results in discontinued blood flow to the compartments and possibly to permanent injury to the muscle and nerves. In extreme cases sufficient pressure to the compartments and the insufficient blood flow will result in the dying of the limb and the need to amputate.

Casts are generally made of plaster but can be occasionally made of fiberglass and other rigid materials. A cast can be fabricated from thin cloth or other thin film material soaked with liquid plaster and rolled around a body part like a bandage. After placing the said material on limb the plaster hardens, thus, providing the required support for the healing body part. Other known casts are prefabricated plastic plasters prepared according to fixed forms and sizes and placed on patient's body part, optionally adjusted with adjusting means such as stripes.

Casts are mainly used for injured bones and soft tissue, reducing pain, swelling and muscle spasm. Casts can also be used for aiding the healing of torn ligaments, tendons and after surgeries. The time period for having a cast can vary and depends on the type of the injury and the healing rate. Thus, some injuries require the cast to remain for a few weeks and others may require the cast remain for a few months. Despite the obvious advantages of a cast as a supportive structure, a major consideration whether to place a limb in cast is the possible danger resulting from the various conditions discussed above related to casts.

Prior art attempts to alleviate the conditions associated with casts use generally require special equipment that is costly, large in size and used mainly in hospitals or day care facilities, but not in the patient's home. One solution provided within the prior art is disclosed within U.S. Pat. No. 4,841,956 issued to Gardner et al. (Gardner) and U.S. Pat. No. 5,218,954 issued to van Bemmelen (Bemmelen). Gardner discloses an apparatus for inducing venous-return flow from leg. According to Gardner the apparatus is comprised from a pressurized gas source, a number of pressure gas inlets and corresponding valves. According to Gardner the apparatus provides repeating cycle of successively actuated venous pumps that enhance the venous-return flow from leg.

Bemmelen discloses an arterial assist device and method. According to Bemmelen the device includes an inflation system that is a separate unit, a connecting tube, a bladder and air releasing valves. Both Gardner and Bemmelen present devices that increase the blood flow within the limb put in cast.

The devices and methods presented within the prior art are bulky and require additional heavy equipment to operate these devices. Furthermore, the prior art devices call for the insertion of a tube, a bladder or both beneath the cast. Because casts are typically formed on the injured body part, the insertion beneath the cast of a bladder or tube must be performed prior to placing the body part in the cast. At this time, in most cases, the injured body part will likely cause severe pain to the patient and holding a bladder or tube to the body part may result in additional suffering. Moreover, once the cast is formed around the body part it will be difficult to ascertain the exact location of the bladder or tube resulting in a non-effective treatment. Additionally, any failure within the equipment will require the removal of the cast. Furthermore, the equipment of the prior art does not provide versatile types of treatments for enhancing the circulation in the cast body part.

There is therefore a need for an apparatus and method that provides people having part of their body encased with a cast an apparatus and method for enhancing the circulation within the body part. Such apparatus would not require the insertion of a bladder or tube below the cast after or prior to placing the cast. Furthermore, there is a need for an apparatus and method that enables a person with cast to receive versatile treatments for enhancing the circulation within the body part.

### SUMMARY OF THE PRESENT INVENTION

The present invention provides an apparatus and method for supporting a body part and for facilitating enhanced circulation therein.

One aspect of the invention is an apparatus comprising a generally rigid supportive structure configured for encasing at least partially said body part; and

a compression unit fully mounted on said supportive structure or on an element thereof wherein the compression unit is adapted for actuating intermittent pressure on said body part. The supportive structure may be a cast construction made of moldable material, a prefabricated cast construction, or a brace.

1. The compression unit, or at least a part thereof, may be integrally formed on the supportive structure or on an element of the supportive structure. Alternatively, the compression unit may be detachably mounted on the supportive structure or on an element thereof. The compression unit comprises at least one compression element and a mechanism coupled thereto for actuating intermittent transitions of the element between a compression position and a relaxed position. The actuator further includes a power source for supplying power to said mechanism. The compression unit may be provided with a control panel for allowing a user to set parameters of the compression unit operation.

2. The compression element of the compression unit may be a movable surface configured to be pressed against the body part wherein the mechanism actuates a reciprocating motion of said movable surface in a direction substantially perpendicular to the surface. The movable surface may be a movable plate wherein the mechanism actuates a reciprocating motion of the plate in a direction substantially perpendicular to the plate surface. Alternatively, the movable surface is the inner surface of a bladder configured to be located juxtaposed to the body part wherein the mechanism includes an air compressor for intermittently inflating the bladder. Alternatively the compression element is a closure encircling at least partially the body part wherein the mechanism actuates intermittent tightening of the closure around said body part. The closure may be a strap encircling the body part wherein said mechanism intermittently pulls and releases at least one end of the strap for intermittently tightening said strap around said body part. Alternatively, the closure may comprise at least one flap which partially encircles the body part wherein the mechanism intermittently moves said at least one flap relatively to the body part for applying squeezing force on said body part.

3. A second aspect of the invention is a cast element adapted to be incorporated into a supportive structure for facilitating enhanced circulation in a body part supported by said supportive structure, wherein the cast element comprises at least one compression unit adapted to actuate intermittent pressure on said body part. The compression unit may be an integral part of the cast element or may be detachably mounted in an opening of the cast element.

4. A further aspect of the invention is a method for enhancing circulation in a body part in need of support. The method comprises, comprising the steps of supporting said body part by a supporting structure wherein the supporting structure is provided with at least one intermittent compression unit fully mounted thereon; and activating said intermittent compression device to apply intermittent pressure on said body part. According to one embodiment of the method, the supporting structure is provided with at least one opening for leaving at least one portion of the body part uncovered by the supporting structure and the compression unit applies intermittent pressure by intermittently moving a movable surface in a reciprocating motion against said uncovered body portion. According to another embodiment, the compression unit comprises a closure for encircling at least partially the body part and the compression unit applies intermittent pressure by intermittently tightening and releasing said closure.

### BRIEF DESCRIPTION OF THE DRAWINGS

The present invention will be understood and appreciated more fully from the following detailed description taken in conjunction with the drawings in which:

FIG. 1A is an overview of an apparatus for the enhancement of circulation within an encased body part, according to one preferred embodiment of the present invention;

FIG. 1B is an overview of one possible location for placing the apparatus of the present invention, according to a preferred embodiment of the present invention;

FIGS. 2A, 2B, 2C, 2D and 2E depict various constructions for detachably installing the compression unit in the cast or in a part thereof;

FIG. 2F depict an embodiment of the invention according to which the intermittent compression unit is an integral part of the cast element;

FIG. 2I depicts an embodiment of the invention according to which the compression unit conforms to the outer surface of the cast element;

FIGS. 3A, 3B and 3C present a side view of an apparatus and mechanism, installed in a cast, according to one preferred embodiment of the present invention;

FIGS. 4A, 4B and 4C present different close-up angles of another mechanism according to the preferred embodiment of the present invention;

FIGS. 5A, 5B and 5C present different close-up angles of another mechanism in accordance with another preferred embodiment according to the present invention;

FIGS. 6A, 6B, 6C and 6D present different close-up angles of another mechanism in accordance with yet another preferred embodiment according to the present invention.

FIGS. 7A and 7B are a front view and a rear view, respectively, of another embodiment of a cast or brace element according to which intermittent compression is actuated by intermittently tightening and relaxing a closure around the body part encased in the cast or brace;

FIG. 8 depicts an embodiment of a brace incorporating the element of FIG. 7;

FIG. 9 illustrates an embodiment of a brace of the invention having a flap as the compression element.

### DETAILED DESCRIPTION OF PREFERRED EMBODIMENTS

The present invention discloses an apparatus and method for intermittent compression of muscles or other tissue for the enhancement of circulation flow in a body part supported by a cast or a brace. The apparatus can provide pain relief and expended healing to fractures and damaged soft tissues as well as alleviate conditions associated with casts as discussed above.

The apparatus according to the present invention overcomes disadvantages of the prior art by providing a cast that is equipped with an intermittent compression unit for effectuating intermittent compressing of the body part supported thereby, thus enhancing the circulation flow within the body part. The compression unit is either an integral part of the cast or is detachably placed in an opening in the cast configured to receive the compression unit. In either case, the unit is a self-contained unit fully mounted on the cast. As such, it does not limit the mobility of the person beyond the limitations caused by the cast itself. It will be appreciated that the use of the term cast in the context of the present invention refers to any rigid support that encased at least partially a body part, including a conventional cast made of plaster or gypsum, as well as a brace fabricated from metal or rigid plastic. When made of plaster, the cast may comprise prefabricated parts or may be directly molded around the body part to be supported. The apparatus of the invention can also be incorporated into a bandage wrapped about a body part for support.

When detachably attached to the cast, the compression unit is mounted in an opening in the cast configured to receive the unit. This allows for removal and re-mounting of the unit according to needs. A cover may be further provided to close the opening in the cast when the unit is removed. In accordance with this embodiment, the compression unit may be designed as an endurable multiple-use unit that can be transferred from one cast construction to another. Yet in accordance with another embodiment, the compression unit may be integrally formed with the cast, or with a part thereof.

The apparatus of the invention can be built in various sizes and shapes to provide solutions for various body parts in need of a rigid support. When the compression unit is detachable, the opening in the cast can be prefabricated or may be opened specifically for the use of the unit after the cast is already in use. Said opening can be sealed when treatment with the device has ended.

The present invention uses different mechanisms for providing intermittent compression. According to one preferred embodiment, the compression unit comprises a compression plate that is moved intermittently against the muscle or other tissue located within the cast. Alternatively, the compression plate can be replaced by an inflatable bladder which intermittently inflates and deflates. Yet, according to a further embodiment, intermittent compression is provided by intermittently tightening a closure that encircles, at least partially, the body part encased in the cast or brace and is located between the body part and the inner surface of the cast. The closure may be a strap, a band, one or more rigid flaps and the like. Different embodiments and mechanisms of the method and apparatus of the present invention are described in association with the figures below. Other possible mechanisms and additional features of the compression unit are described in detail in international publications WO2002069879, WO2005072674, WO05/072674 WO05/120424 WO6/033114 WO06/033115 WO06/035449 and in international application PCT/IL05/000446, the full content of all of which is incorporated herein by reference.

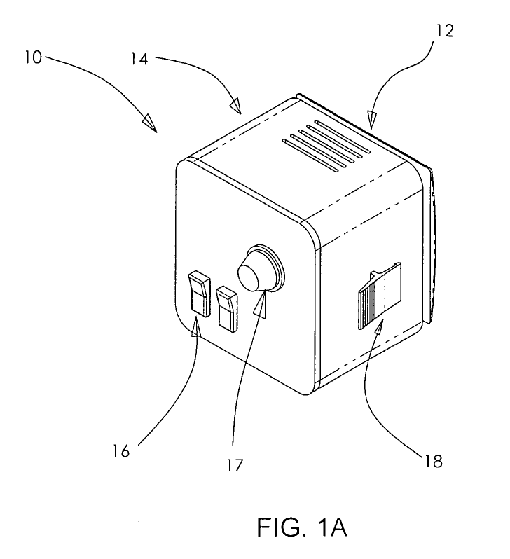

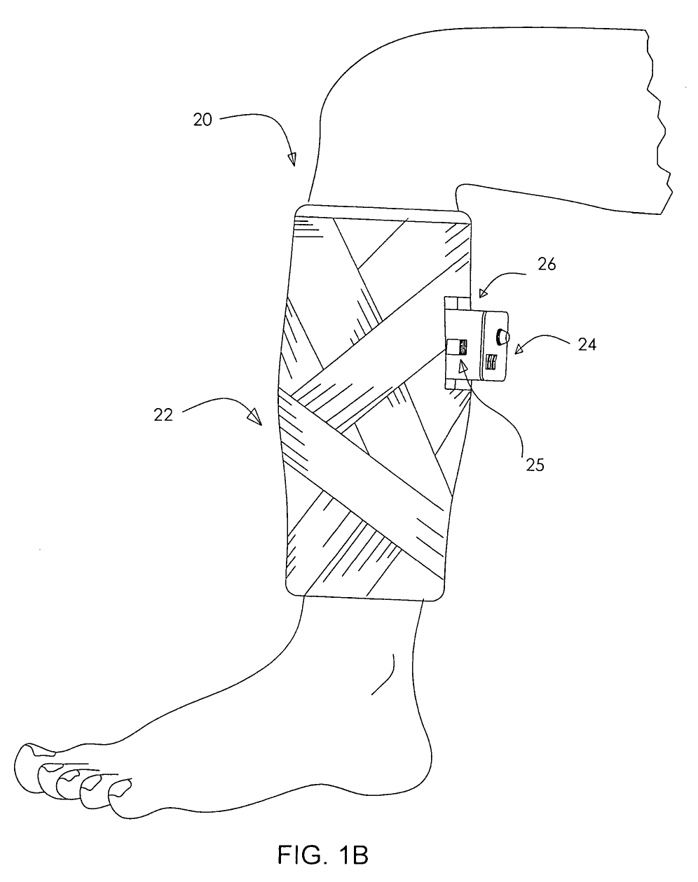

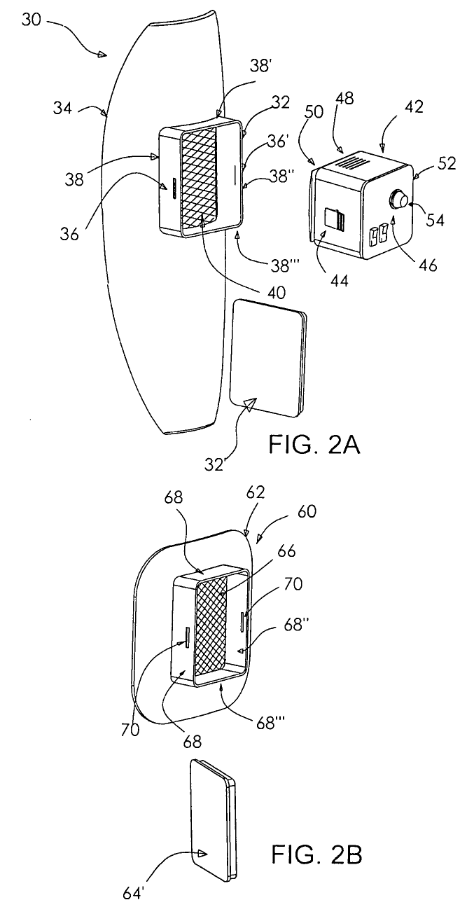

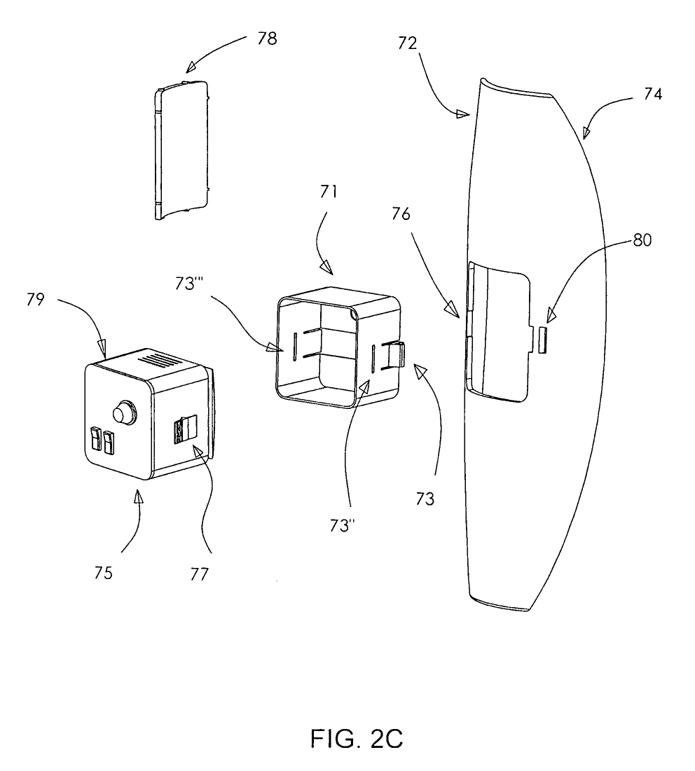

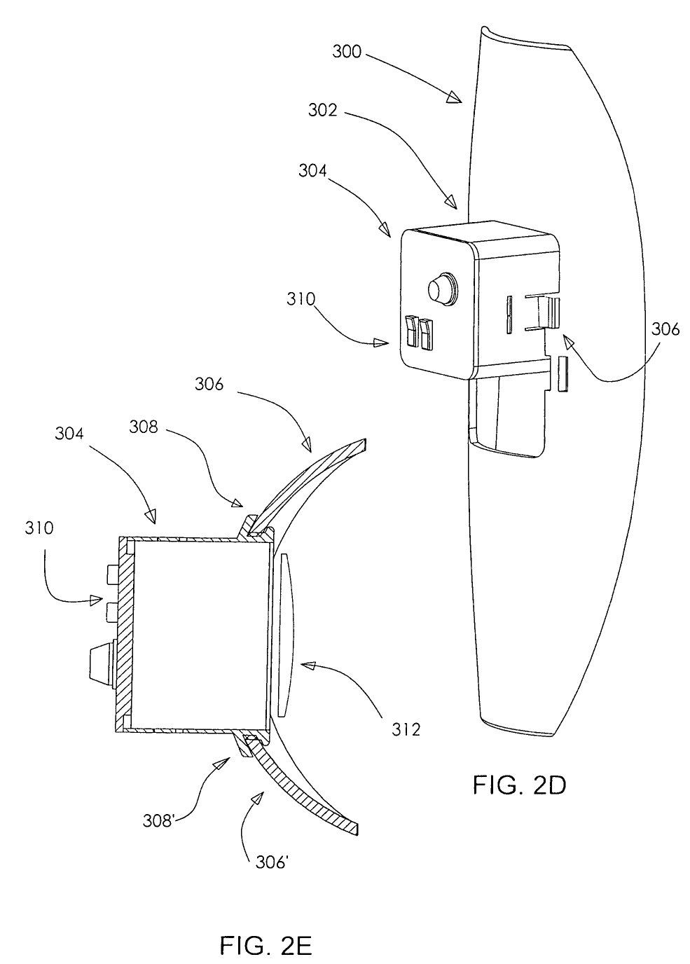

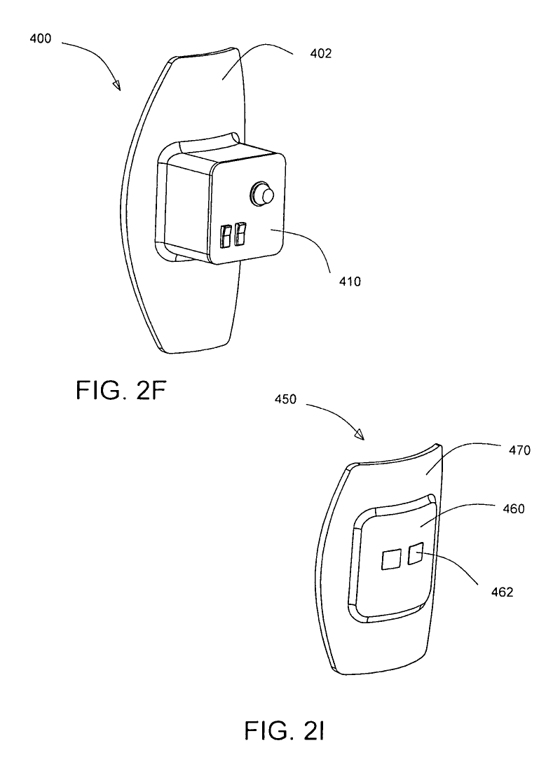

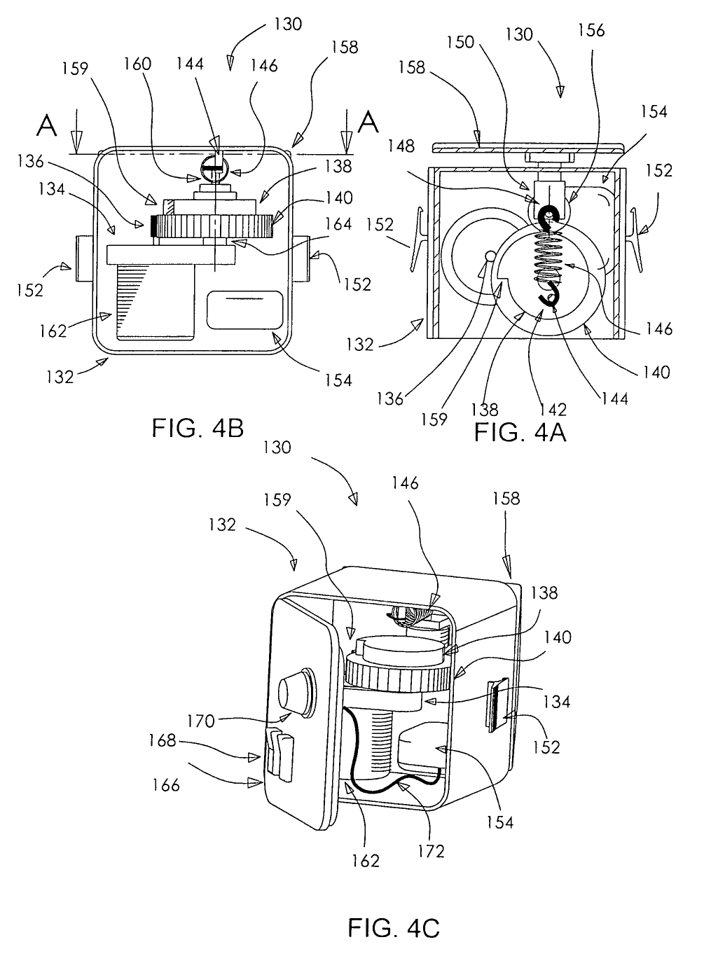

FIG. 1A presents an overview of an apparatus according to one preferred embodiment in accordance with the present invention. The intermittent compression unit (ICU) 10 comprises a housing 14 and an intermittent compressing plate 12. The housing 14 and the plate 12 can be made from any rigid material. Preferably, the plate is made of a strong and light weight material. In the preferred embodiment the ICU is a light weight device so as to enable a user to leave the ICU within the cast opening while the patient can move around. Inside housing 14 there is installed a mechanism (not shown) that upon activation from the control panel switch 16 commences intermittent compressing by compressing plate 12. The rate of the intermittent compressing can be determined by rate control button 17. According to one embodiment housing 14 comprises attaching means that enable the attachment of ICA 10 to a cast as depicted in FIGS. 1B and 2A below. Accordingly, ICU 10 can also include flexible clips 18 and other clip (not shown) attached to housing 14 in parallel side-wall of housing 14. The position of clips can be viewed in FIG. 4A, 4B below. The clips fasten ICU 10 to a box 32 in the opening formed or prefabricated in the cast as depicted in FIG. 2A below. Clips 18 may be fabricated from elastic plastic material, elastic metal or other material. Accordingly, clip 18 attaches housing 14 and entire ICU 10 to the opening in the cast encasing a body part as depicted below in view of FIG. 1B. Persons skilled in the art will appreciate that other mechanisms for controlling the ICI can easily be added. Such can include computerized programs for providing session treatments for patients wearing the ICU, various sensors for providing information about the conditions underneath the ICU compression plate 12 which can be linked to computerized mechanisms for controlling the ICI and the program provided to the patient. Various other indicators can also be added, such as LEDs for indicating that the ICU is turned on, or indicating which compression rate or program has been selected as well as a small LCD panel for further providing such information as well as battery strength indicator and the like. The ICU can be formed in various sizes and shapes. The ICI shown is an exemplary shape and in the preferred example, the ICU is manufactured in sizes which can fit various body parts which are put in casts. According to one preferred embodiment of the present invention the ICU comprises only one control panel switch 16 which turns on or off the ICU mechanism, said compression rate is fixed.

Referring now to FIG. 1B, there is shown one possible location of the ICU in a cast 22 supporting a leg. FIG. 1 shows a portion of a leg 20 that is put in cast 22. In FIG. 1 Cast 22 surrounds leg portion 20. In other preferred embodiments of the present invention the cast can be placed on a limb or other body part. The cast can be placed on part of the limb or body part extending the circumference or a part of said limb or body part. In yet another embodiment of the present invention the cast can be placed on a specific location on the body part resembling a bandage. In the exemplary embodiment shown here, a physician or a paramedic as result of a diagnosis of a bone fracture or bone crack or tissue damage or post surgery can place the cast 22 on the leg. According to the present embodiment ICU 24 is portable and enables person wearing a cast to position the ICU without assistance. In accordance with the embodiment shown here, ICU 24 is detachably placed within a pre-fabricated opening 26 in cast 22. Opening 26 can be a pre-fabricated piece of cast manufactured with cast 22 in case the cast is prefabricated or an opening made after the cast is prepared correlating to the ICU 24 dimensions.

When prepared after the cast is made the opening will be made by a physician using the standard tools for opening casts to cut the opening according to size of the used ICU and in a position on leg 22 which will allow optimum muscle or other tissue compression for achieving the best circulation as a result of muscle or other tissue compression. The intermittent compression activated by ICU 24 can be activated adjacent to a partitioning material, such as a bandage or gauze between the compressing plate 12 from FIG. 1A and the body portion as depicted in view of FIG. 2A below. Alternatively, compressing plate 12 can be positioned adjacent to the body part without any partitioning. According to one preferred embodiment opening 26 and ICU 24 are placed adjacent to gastrocnemius muscle and is able to implement intermittent compression on the muscle for enhancing circulation flow within the blood artery and veins consequently from the compression on the muscle. The intermittent compression is activated by the compressing plate depicted in FIG. 1A above or other equivalent element according to various preferred embodiment as depicted below. In accordance with the embodiment shown here, ICU 24 is attached to cast 22 with one or more clips 25 and another one or more parallel positioned clips on other side of ICU 24. According to the preferred embodiment only part of clip 25 can be viewed when ICU 24 is attached to cast 22. A user can remove ICU 24 from cast 22 by pressing clips 25 towards ICU 24 and pulling ICU out from cast. If more than two clips are used a single release mechanism is used to enable a quick and easy release of the ICU 24 from opening 26. Removing ICU 24 can be performed as result of changing a battery, attending a technical problem within ICU 24, replacement of ICU 24 with another ICU or for other reasons. Persons skilled in the art will appreciate that the cast shown and the leg put in cast are merely one preferred embodiment of the present invention. According to other preferred embodiments the cast can be shorter or longer, on other limbs or body parts, positioning ICU 24 in other positions and having more than one ICU in the same cast.

FIGS. 2A, 2B present two different preferred embodiments of cast installed construction associated with the ICU of the present invention. The cast-installed construction ICU is used for holding the unit according to some preferred embodiments of the present invention. The case shown in association with FIGS. 2A, 2B, 2C, 2D, 2E is a prefabricated cast. Such casts are made in various sizes and shapes to fit various body parts and person sizes. It will be evident that the ICU of the present invention can be installed in a like manner as is described below in other casts, such as mold casts and the like. According to a preferred embodiment a cast-installed construction ICI is placed adjacent to a body part within the cast that is to be intermittent compressed by the apparatus. Construction 30 shown in FIG. 2A can be used according to one preferred embodiment of the present invention within a plastic or like cast. Construction 30 is prefabricated from a stiff plastic material panel or other material having a shape that fits a limb. Box 32 is forged within construction 30 placing it in a location that will be adjacent to the body part to be intermittent compressed when place on limb. According to one preferred embodiment, box 32 is constructed from a rigid material such as plastic or other rigid materials and the like. Box 32 has a base 40 planar shape and box walls 38, 38′, 38″ and 38′″. According to the preferred embodiment ICU's 48 dimensions corresponds to box 32 dimensions. Thus, ICI 48 can be placed within box 32, held firmly there within and operate intermittent compression on body part adjacent to base 40. Base 40 according to one preferred embodiment can be fabricated from a flexible, water resistant material such as a flexible plastic or other material. The flexibility of base 40 is required for the intermittent compression performed according to one preferred embodiment by compressing plate 50. In other embodiments base 40 is not included with construction 30. In yet another embodiment the base 40 is fabricated from a light material which allows the exchange of fluids and gases from the inside portion 34 of construction 30 thus allowing ventilation of the body part throughout the use of the ICU and thereafter.

Still referring to FIG. 2A, walls 38, 38′, 38″ and 38′″ are rigid and support ICU 48 when inserted in to box 32. Walls 38 and 38″ according to the preferred embodiment include clefts 36 and 36′ that correspond to clip 44 attached to side-wall of housing 42 of ICU 48 and to another clip (not shown) parallel to clip 44 attached to other side-wall of housing 42. In an alternative embodiment more than one cleft can be positioned on walls of box 32 to accommodate the more than one clips 44. The clips attached to ICU 48 are further described in association with FIGS. 4A, 4B below. Concurrently after placing ICU 48 within box 32, clips 44 and parallel clip hold firmly ICU 48 in position for commencing the operation of ICU 48. The operation of ICU 48 is commenced by movement of switches 46 placed on control panel 52 positioned on the back part of housing 42. Once ICU 48 is positioned within box 32 a user, the patient, a nurse, physician or another, can commence or cease the operation of ICU 48. Optionally, the intermittent compression rate can be controlled with control button 54. According to the preferred embodiment after inserting ICU 48 within box 32 control panel 52 faces the exterior part thus enabling accesses to control panel 52. One skilled in the art can appreciate that many other embodiments of the present invention can be described such as different shaped boxes and ICUs with other characteristics, different attaching means of ICU to box as well as many other variations of the embodiment described in association within FIG. 2A. According to one preferred embodiment ICU 48 can be protruded out of the box 32 and out of cast as depicted in association with FIG. 1B above. Accordingly, part of the ICU 48 can be viewed with control panel 52. According to another preferred embodiment ICU 48 does not protrude from box 32 and in order to activate or deactivate ICU 48 there is a need to approach control panel 52 within box 32. According to another embodiment box 32 has a cover 32′ that is placed on box 32 prior to placing ICU 48 within box 32. Accordingly, when user wishes to insert ICU 48 cover 32′ is removed from box 32. According to another embodiment cover 32′ can be placed over ICU 48 placed within box 32 when in operation or not.

Referring now to FIG. 2B showing another embodiment of a cast installed construction, in accordance with a preferred embodiment of the present invention. Construction 60 is comprised from a stiff plastic material panel 62 and a box 64. Construction 60 can be used for a plaster laid cast or the like. Accordingly, construction 60 is placed adjacent to the body part location of where the ICU is to be placed for enhancing circulation flow. After placing construction 60 at the appropriate location, the laying of the wet cast bandage around or on the body part and panel 62 is performed. Once the wet bandages are dry the cast including the protruded cast box 64 are ready for use in connection with the ICU. Next, the ICU 48 may be inserted or plugged in to box 64. Box 64 according to one preferred embodiment includes walls 68, 68′, 68″ and 68′″ that are fabricated from rigid plastic material or other material and a planar shape base 66. Base 66 can be a flexible thin plastic material or other material which can be transparent, fluid resistant or that allows fluid and gases to flow there through. Walls 68 and 68″ include one or more clefts 70 and 70′ respectfully. One or more clefts 70 and 70′ are adjusted to hold one or more clips 44 and other one or more clip (not shown) attached to ICU 48. According to another embodiment of the present invention a box may not include a base at all, thus, compressing plate 50 activates intermittent compression directly on the body part's tissue. According to another embodiment box 64 or 32 may include a box cover described in association with FIG. 2C below. According to another embodiment box 64 has a cover 64′. According to the preferred embodiment cover 64′ can function similarly to cover 32′ described in association with FIG. 2A above. Hence, cover 64′ can be placed on box 64 prior to the insertion of ICU 48 or placed after the insertion of ICU 48 within box 64. Cover 64′ as will cover 32′ provide a sealable cast part which can assist in maintaining the cast area sealed to minimize the risk of foreign objects falling or entering the areas between the body part and the cast.

Referring now to FIG. 2C showing another embodiment of a cast installed construction. Construction 72 forming a part of or the cast includes a rigid panel 74, similar to the embodiment shown in FIG. 2A above. Construction 72 includes opening 76 and cover 78. Opening 76 is positioned according to the preferred embodiment of the present invention adjacent to a body part. Opening 76 can include a box 32 or 64 as shown and described in association with FIGS. 2A and 2B respectively. Alternatively, box 71 with special adjusted one or more clips 73 and another one more parallel positioned clips 73′ (not shown) on the other side of box 71 can be placed within opening 76. One or more clips 73 and 73′ attach box 71 to cast and provide a housing for ICU 75. One or more clips 73, 73′ attach box 71 to construction 72 by closing one or more corresponding clefts 80, 80″ (not shown). In an alternative embodiment box 71 could include other means for attaching box 71 to construction 71, such as flaps having rails and slits located on construction 71 and the like.

Still referring to FIG. 2C, ICU 75 with housing 79 has one or more clips 77 and parallel positioned one or more clip 77′ (not shown). Clips 77, 77′ may be located at each side of box 71 as it may easier to release clips 71, 71′ if located at the upper and lower sides of box 72. Box 71 includes further one or more slits 73″ and 73′″ that correspond to one or more clips 77 and 77′ of ICU 75. Accordingly, a limb or other body part can be encased with cast (not shown) with an opening 76 covered with cover 78. To provide the relevant body part with intermittent compression cover 78 is removed from opening 76. Hence, providing the possibility to insert box 71. Box 71 is positioned in opening 76 and attached to rigid panel 74 placed within cast (not shown) with one or more clips 73 and 73′. According to the preferred embodiment one or more clips 73 and 73′ are fabricated from rigid flexible plastic material. However, according to other embodiments the one or more clips can be fabricated from other suitable rigid materials. After placing and attaching box 71 within opening 76 ICU 75 is placed within box 71. ICU 75 is attached to box 71 with clips 77 and 77′. After attaching ICU 75 to box 71 the operation of ICU 75 can be commenced, thus, providing intermittent compression to body part adjacent to opening 76. In another alternative embodiment opening 76 may not include a box at all. Accordingly, ICU 75 can be place directly within opening 76 within construction 72. Accordingly, one or more clips 77 and 77′ attach ICU 75 to rigid panel 74. The size of opening 76 is manufactured such that it can fit box 71 or ICU 75 as the case may be. The location of opening 76 can be predetermined so as to allow efficient treatment to the tissue receiving intermittent compression through the use of ICU 75. More than one opening can be used in connection with construction 72 and other constructions shown in association with the present invention, such that one or more openings 76 can be manufactured in predetermined locations according to the type of cast, the person, condition of patient and other like considerations.

FIGS. 2D and 2E show another preferred embodiment of a construction and ICU in accordance with the present invention. Accordingly, cast installed construction 300 placed within or in association with cast (not shown) has ICU 304 positioned within opening 302. Opening 302 is placed adjacent to location within encased in cast body part to receive intermittent compression for enhancing circulation flow. ICU 304 is attached to cast installed construction 300 with one or more clips 306 and 306′ shown in association with FIG. 2E and having at least one control panel 310 of ICU 304 facing out or up or to any one of the sides of ICU 304. Accordingly, one or more clips 306 and 306′ are formed from rigid material such as plastic or other like material and are connected to one or more hinges 308 and 308′, respectively. Hinges 308 and 308′ are positioned adjacent to compressing plate 312. After placing ICU 304 within opening 302 one or more clips 306 and 306′ are bent towards control panel 310. A user can commence and cease the operation of ICU 304 from control panel 310 or from a remote control panel (not shown). In yet another embodiment the control for the ICU can be performed from a remote location such as for example by a physician or another person. The ICU 304 can be connected via a communications device such as a modem to a communications network such as a cellular or LAN or WAN communications network to a remote control panel which is operated without the assistance of the user. User can remove ICA 304 from opening 302 by compressing one or more clips 306 and 306′ towards ICU 304 as presented in FIG. 2D and drawing it out once use is complete. It will be evident to one skilled in the art that the user can leave ICU 304 in opening 302 even when it is not used. Once ICU 304 has been removed the suitable cover can optionally be placed back onto penning 302 thus sealing the cast.

FIGS. 2A to 2E illustrate various embodiments according to which the intermittent compression unit is detachably mounted on the cast or on a part thereof. In accordance with these embodiments the ICU may be removed and re-mounted in accordance with the patient's needs and may be utilized for more than one patient. However, in accordance with other embodiments of the invention the ICU may be integrally formed with the cast or with a portion thereof. FIG. 2F depicts a cast element, generally designated 400, comprising an ICU 410 which is integrally formed with cast portion 402. In accordance with this embodiment, cast portion 402 is an integral extension of walls 412 of ICU 410. Cast element 400 may assume different shapes and sizes as described above in association with FIGS. 2A and 2B. Thus, cast portion 402 may comprise only a relatively narrow rim around ICU 410 to allow incorporation of the unit into a molded plaster when molded to form a support around a body part. Alternatively, cast element 400 may be a prefabricated cast or brace, or a part thereof. Further, the ICU unit may be designed to be of such dimensions so as to conform to the outer surface of the cast element. FIG. 2I depicts such an embodiment, designated 450, where ICU unit 460 is fully nested within cast element 470 and where the outer surface of ICU 450 and the outer surface of cast element 460 confirm to each other. As illustrated here, control buttons 462 may be touch buttons so as to afford a smooth surface where none of the ICU elements extends beyond the outer surface of the supportive structure.

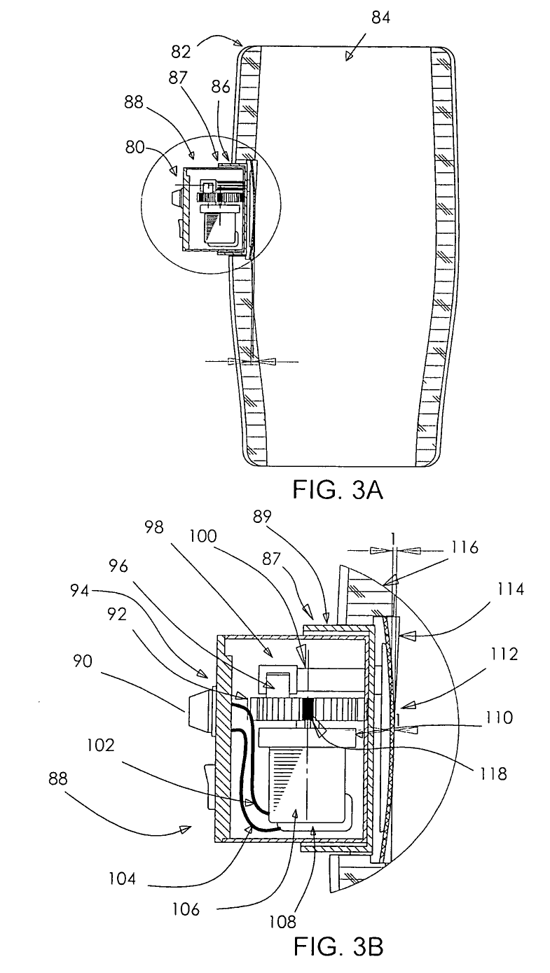

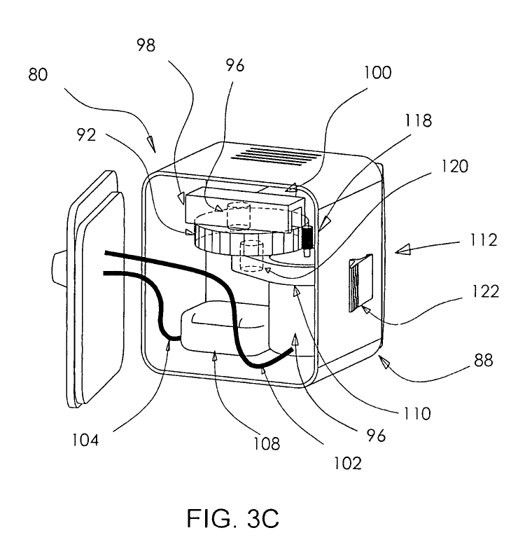

Turning now to FIG. 3A shows a cross sectional side view of an apparatus and mechanism, installed in a cast, according to one preferred embodiment of the present invention. ICU 80 is placed in opening 86 within cast 82. Cast 82 is placed on limb or body part 84 that may be a calf or any other limb or body part. While cast 84 is shown to fit the shape of a leg the cast may be put on limbs or other body parts. The opening 86 can optionally include a box or a frame 87 as depicted in view of FIGS. 2A and 2B to hold ICU 80 within said box or frame. In yet additional alternatives, the ICU 80 may be held by straps or by other means in such manner that the patient may easily place ICU 80 in opening 86 without the assistance of another person. ICU 80 can be placed in opening 86 prior to commencing the intermittent compression activation or alternatively when installing the cast on limb or other body part.

Referring now to FIGS. 3B and 3C showing ICU 80 in greater detail. FIG. 3B shows a detailed plenary close-up side view of ICU 80. FIG. 3B and FIG. 3C show an isometric overview and internal view of ICU 80. According to the preferred embodiment ICU 80 comprises components for activating an intermittent compression on an adjacent body part positioned opposite compressing plate 112. ICU 80 comprises a housing 88 placed in accordance with the present embodiment in box or frame 87. Box or frame 87 preferably comprises a flexible base 114 and has four walls of which only 89 and 89′ are shown in FIG. 3B. Box or frame 87 is used as a receptacle for ICU 80. The box or frame 87 is suitably sized to fit ICU 80. ICU 80 is placed within box or frame 87 such that ICU 80 slides into box or frame 87 and is attached thereto. A rail (not shown) can guide ICU 80 into box or frame 87. One or more clips or protrusions on box or frame 87 may accommodate recessions on ICU 80 for allowing a good grip of ICU 80 within box or frame 87. A latch or like device (not shown) may be used to secure ICU 80 into its parking position within box or frame 87. ICU 80 includes a rechargeable battery 108 connected via wiring 104 to control panel 94. Control panel 94 preferably includes rate control button 90 and a start/stop button (not shown) for initiating the intermittent compression operation of ICU 80. Control panel 94 is connected to motor 106 via wiring 102. Motor 106 can be any one of several motors known in the art such as a rotary vane motor, diaphragm motor manufactured by Gast Manufacturing Inc. from Benton Harbor, Mich., U.S.A., an electrical motor, a magnetic motor, a mechanical or any other suitable motor. Cogwheel 118 is connected via shaft or directly to motor head 110 placed on motor 106 and turns cogwheel 92. Cogwheel 92 has its pivot 120 positioned on motor head 110 and can be seen in FIG. 3C. Ledge 96 is placed on cogwheel 92 and turns in an eccentric manner about the pivot 120 clockwise or anticlockwise synchronously with cogwheel 92. Crank 98 is attached to ledge 96 and to crankshaft 100. Crank 98 transfers the motion of cogwheel 92 via ledge 96 to crankshaft 100. Crankshaft 100 is a shaft attached to compression plate 112. Operation of motor 106 turns pivot 120 which turns cogwheel 92 that in turn moves crank 98 resulting from the movement of ledge 96. Consequence from the movement of crank 98 crankshaft 100 movement performs the intermittent compression performed by compressing plate 112. The size of cogwheel 92 and the speed of the motor determine the intermittence interval. The intermittence interval can be easily adjusted by increasing or decreasing the speed of the motor or alternatively the rotation speed of pivot 120. Likewise a change in the circumference of cogwheel 92 or the location of ledge 96 about cogwheel 92 will also alter the intermittence interval and therefore the treatment provided by the ICU 80. According to the preferred embodiment compressing plate activates intermittent compression on base 114 that accordingly inclines to adjacent skin or tissue. Consequently, the intermittent compression of the tissue and the blood vessels therein enhances the blood and lymph and the circulation flow. The intermittent compression rate can be adjusted with rate control button 90 prior to commencing the compression or during to the compressing operation. The compression rate can adjust any of the elements which may affect the intermittence interval. As can be seen from FIG. 3C in accordance with one embodiment of the present invention, clip 122 attaches ICU 80 to cast 82 by attaching housing 88 to box or frame 87 viewed in FIG. 3B. While one or more clips can be positioned on either side of ICU 80 for the sake of convenience only clip 122 is shown. Clip 122 and parallel clips (not shown) can be elastic plastic material or fabricated from elastic metal or other materials. ICU 80 is pressed perpendicular to opening 86 and box or frame 87. Upon the insertion of ICU 80 into box or frame 87 elastic clip 122 and parallel clips (not shown) are pressed against walls 89, 89′ or other walls of box or frame 87, thus, attaching ICU 80 to box or frame 87 and to cast 82. One skilled in the art can appreciate that similarly result of attaching ICU 80 can be reached by using other types of clips or a strap for attaching ICU 80 to cast 82.

Referring now to FIGS. 4A, 4B, 4C showing another preferred embodiment of the mechanism of ICU according to the present invention. A quick intermittent compression movement of the compressing element of ICU 130 is shown. ICU 130 comprises a housing 132, a compressing plate element 158 and control panel 166 shown in FIG. 4C. Housing 132 includes the mechanism enabling a quick intermittent compression movement of the compressing element 158. FIG. 4A shows a cross section of the mechanism within housing 132 of ICU 130. FIG. 4B shows a side view and FIG. 4C shows an isomeric view of housing 132, the control panel 166 positioned at a semi-open position. Motor 162 and battery 154 may have the same characteristics of motor 106 and battery 108 depicted in association with FIGS. 3A, 3B, 3C respectively. Battery 154 can be any mobile power source. Battery 154 is connected via connecting wiring 172 to control panel 166. Motor 162 is also connected via connecting wiring (not shown) to control panel 166. ICU's 130 operation is regulated by switches 168 and rate control button 170. Switches 168 include an on/off switch for turning ICU 130 on and off. Rate control button 170 enables a user to regulate the intermittent compression of compressing plate 158 by controlling the intermittence interval. Cogwheel 136 is attached to motor 162 and turns larger cogwheel 140. The pivot 164 of cogwheel 140 is positioned on motor head 134. Coupled to cogwheel 140 is disk 138 that turns concurrently with cogwheel 140. Disk 138 includes a cam thus having an irregular perimeter or shape. Disk 138 is shaped as having of varying curvature radius having a gradual slope at one end and a cam with cusp 159 where the radius changes abruptly from a maximum position to a minimum position. Bearing 156 is a “cam follower” bearing that is positioned against disk 138 with spring 146. Bearing 156 is connected pivotally with pivot 160 to shaft 150. Shaft 150 is attached to compressing plate 158. Hook 148 of spring 146 is placed around pivot 160 at one end and other hook 142 around ledge 144 at the other end. Ledge 144 is connected to the upper top of housing 132. The intermittent compression is activated when switches 168 are pushed to the “ON” position. Activation of motor 162 results with the concentric turning of cogwheel 136 and in turn of cogwheel 140. Next, disk 138 coupled to cogwheel 140 is initiated. As consequence of the fact that bearing 156 is positioned against disk 138 by spring 146 compressing plate 158 when turning at cusp 159 performs a swift intermittent compression. Cusp 159 triggers a swift movement of compressing plate 158 resulting from pivotal connection to shaft 150. FIGS. 4A, 4B, 4C show clips 152 and 152′ positioned on each side of housing 132. Additional clips may be located on each side of ICU 130. Clips 152 and 152′ attach and hold ICU 130 to opening and alternatively to a box or frame attached to the cast. Clips 152 and 152′ enable the attachment of ICU 130 to an opening in cast such as shown in the above figures. ICU 130 can be placed within opening of cast (not shown) by the patient or by another person. Upon activating of ICA 130 or other ICU intermittent compression is commenced that enhances the circulation within the associated body part.

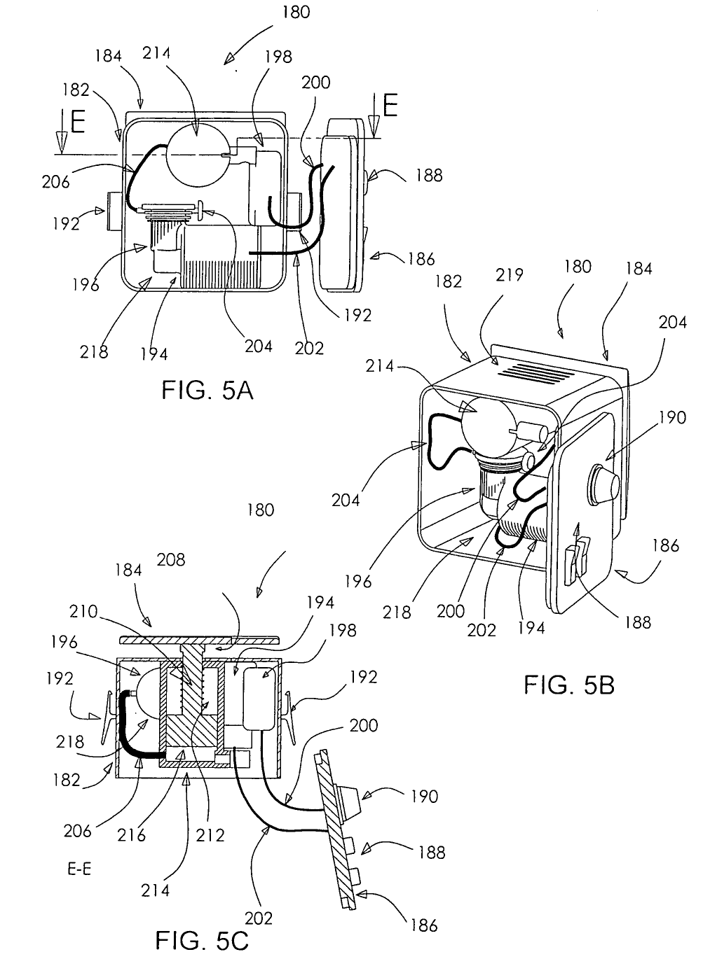

Turning now to FIGS. 5A, 5B, 5C showing yet another preferred embodiment of the ICU according to the present invention. FIG. 5A presents a housing 182 that has its control panel 186 open. FIG. 5B shows an overview of ICU 180 with control panel 186 being open. FIG. 5C shows a cross section of the mechanism shown in FIG. 5A. The preferred embodiment shown in association with FIGS. 5A, 5B, 5C relates to a pneumatic mechanism that provides intermittent compression to a tissue of a body part placed within a cast. Accordingly, Hosing 182 includes a rechargeable battery or other power source 198 that is connected to control panel 186 via wiring 200. Air compressor 218 is connected to control panel 186 via wiring 202. Compressor 218 comprises a motor 194 and a cylinder 196. Filter 204 provides the entrance passage to air entering cylinder 196. Air entering and exiting from ICU 180 is conveyed through opening 219 in housing 182. On/off switch 188 positioned on control panel 186 allows the patient or user to turn the ICU 180 on or off. Control panel 186 can also comprise an intermittent rate control button 190 for regulating the intermittent compression performed by compressing plate 184. The regulation of the intermittent compression rate can be performed by regulating the electric power supplied by motor 194. Air from cylinder 196 is conveyed by conveyer pipe 206 to chamber 216 within cylinder 214. Upon entering of pressurized air to chamber 216 within cylinder 214, cylinder shaft 208 moves towards compressing plate 184. Movement of compressing plate 184 together with spring 210 performs intermittent compression against the tissue or base of box or frame located within cast opening. A one-way air release valve (not shown) can be used to release the air from chamber 216. The one-way air release valve is preferably controlled by a microcontroller (not shown). The rate of release of air can be adjusted by the intermittent rate control button also connected to the microcontroller. One or more clips 192 and 192′ can be used to attach ICU 180 to cast as shown in association with the figures above.

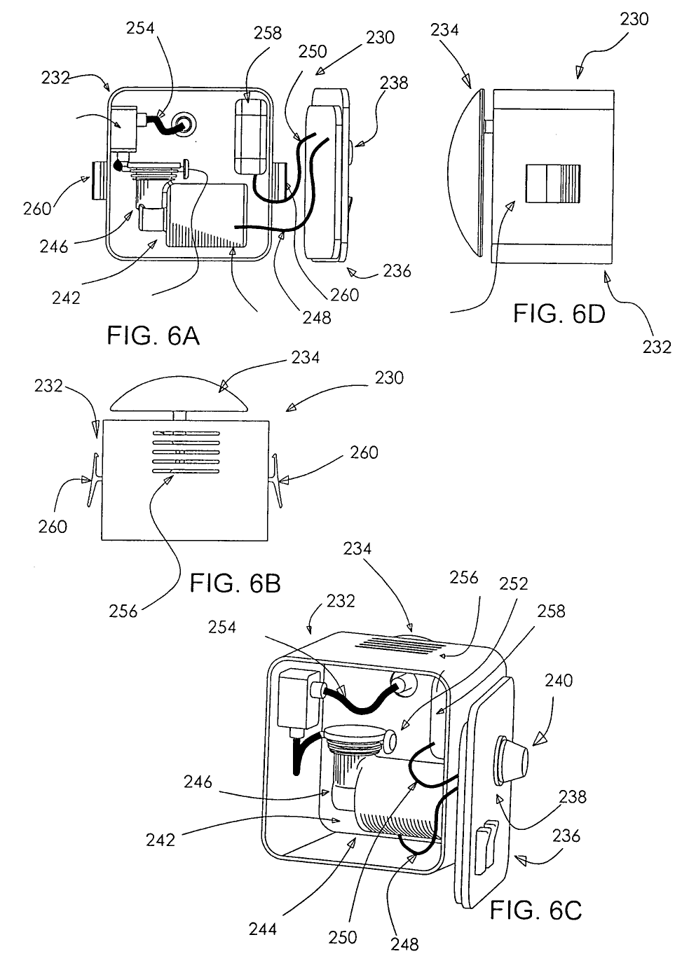

FIGS. 6A, 6B, 6C, 6D show another preferred embodiment according to the present invention. According to this preferred embodiment a pneumatic mechanism activates intermittent compression by ICU 230. ICU 230 comprises a housing 232, a bladder 234 and control panel 236. FIG. 6A shows a side view housing 232 with control panel 236 removed. FIG. 6B shows a top view of ICU 230. FIG. 6C shows an isometric view of ICU 230 with control panel 236 removed. ICU 230 mechanism comprises a compressor 242 and a rechargeable battery 258 or like power source. Battery 258 is connected via wiring 250 to control panel 236. Control panel is connected via wiring 248 to compressor 242. Alternatively, control panel 236 is connected to a microcontroller (not shown) controlling the operation of ICU 230. Accordingly, battery or power source 258 is connected to the microcontroller. Air compressor 242 comprises motor 244 and cylinder 246. Air enters cylinder 246 via filter 252. Air entering and exiting housing 232 through opening 256. Compressed air leaving cylinder 246 is conveyed via conveyor pipe 254 to bladder 234. In turn bladder 234 inflates and pressure is applied to the tissue of the body part placed in the cast. A one-way air release valve (not shown) is located within or connected to cylinder 246. Air release valve is also connected to the microcontroller. Intermittent rate control button 240 connected to the microcontroller enables the patient to control the rate of inflation and deflation of bladder 234 and thus the rate of intermittent compression. [The rate of compression is preferably between ______ to about ______ compressions every minute—Jonathan—please complete missing parts or omit the sentence]. The air release valve can also include a second air pump (not shown) for fast pumping of air located within bladder 234, thus allowing for fast transition between the inflated and deflated positions. Alternatively, air pumping direction can be changed to allow the same result. According to the intermittent compression rate set by the patient or user microcontroller (not shown) instructs air pump to either pump in or pump out air from cylinder 246 located in direct path with bladder 234. In yet another embodiment the one way air release valve can be located on the path of air conveyor pipe 254 and connected to the microcontroller for allowing and even faster air release from bladder 234. Each of the above components can be supplied with standard current through battery and associated current controlling circuits (not shown). As shown in association with previous figures one or more clips 260 and 260′ on either side including top or bottom sides (not shown) show one exemplary manner for attaching the ICU 230 to the cast surrounding or applied to the body part.

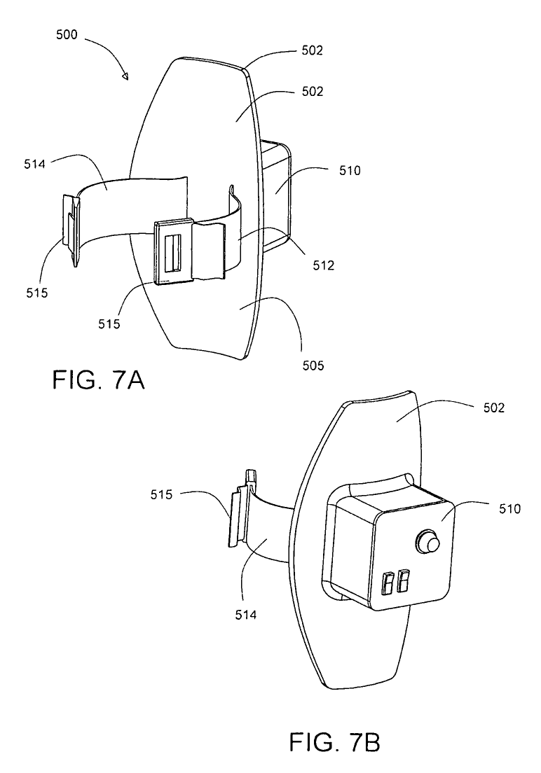

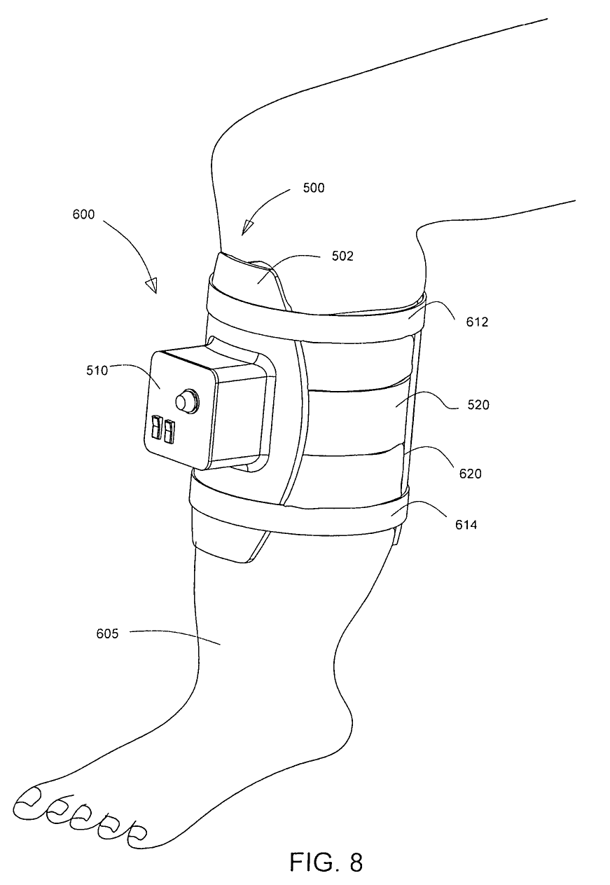

Turning now to FIGS. 7 and 8 there are shown further embodiments of cast elements of the invention according to which intermittent compression is applied to the body part by intermittently tightening and releasing a closure that encircles, at least partly, the body part supported by the cast or brace. FIGS. 7A and 7B depict a cast element, generally designated 500, comprising a cast portion 502 and ICU 510. ICU 510 may be a detachable component or may be integrally formed on portion 502. A closure 520, coupled to inner machinery of ICU 510, is extending from the inner surface 505 of cast portion 502. Closure 520 is adapted to encircle at least partly the body part supported by the cast or brace. As shown here, closure 505 is a strap comprising two flexible portions 512 and 514 provided with fasteners 515 to allow fastening the two portions to form a loop. Strap portions 512 and 514 are threaded through notches 516 in cast portion 502 and are connected to the machinery of ICU 510 that intermittently pulls and release at least one strap portion, thereby applying intermittent compression on the limb encased in the cast construction. It will be realized that closure 510 may assume other forms and other fastening means than shown here. Alternatively, the closure encircling the limb may comprise one or more rigid or semi-rigid arched flaps that conform to the body part supported by the supporting structure but that do not necessarily encircle the body part completely. Intermittent compression is generated in this case by intermittently moving the flaps so as to cause squeezing forces on the body part. A detailed description of various closure means as well as of various mechanisms for intermittently tightening and releasing the closure can be found in the international publications listed above, the full content of all of which is incorporated in the present application.

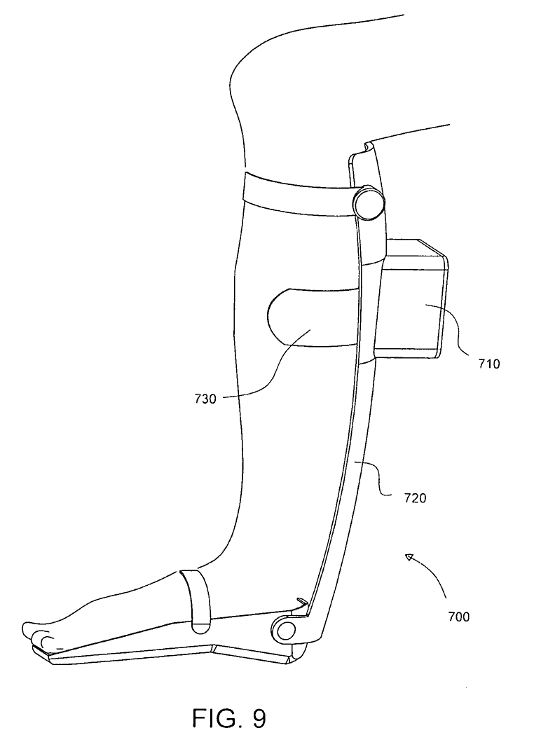

The cast element of FIG. 7 may be a separate part adapted to be incorporated into a brace device when the brace is fastened about a limb or may be integrally formed as part of a brace. FIGS. 8 and 9 demonstrate two embodiments of a brace of the invention having a compression unit that actuates intermittent compression by intermittent tightening a closure around the limb embraced and supported by the brace. In accordance with embodiment 600 of FIG. 8, a cast element, such as a cast element 500 of FIG. 7, and a brace device comprising a back plate 620 and two embracing elements 612 and 614 are fastened around limb 605. Brace elements 612 and 614 may be permanently fastened to cast element 500, in which case embodiment 600 is fastened to the limb as a one piece. Alternatively, cast element 500 may be fastened to limb 605 by closure 520 prior to the fastening of brace 610. FIG. 9 demonstrates another brace embodiment, generally designated 700, according to which a compression unit 710 is mounted, either permanently or detachably, to the back plate 720 of a brace device that supports both foot and calf. Compression unit 710 comprises two arched rigid flaps 730 (only one can be seen). Flaps 730 conform to the leg supported by brace 700 but do not encircle it completely, and apply intermittent pressure on the leg by intermittent clamp-like movement. A detailed description of a compression unit provided with flaps as well as detailed description of mechanisms actuating the same can be found in association with FIGS. 9-13 of WO06/033115, the full content of which is incorporated herein by reference.

In addition to the examples shown above, it will be apparent to the person skilled in the art that the device of the present invention can be readily used for the enhancement of circulation in many various situations and to treat various ailments or conditions. Such include persons sitting or laying for long periods of time (for example, during long air flights or car travels or long hours working at the sitting position or immobilization at the hospital or rehabilitation center and the like.) It will be apparent that it may also be used for the enhancement of circulation such as lymph and blood flow of patients with diseases such as Diabetes Mellitus and Burger's disease. Also, for the enhancement of lymph and blood flow in the hand of a patient post mastectomy. Other uses not described here above will be apparent to the person skilled in the art. Providing said examples is made for the purpose of clarity and not limitation.

1. An apparatus for supporting a body part and for facilitating enhanced circulation therein, comprising:
a generally rigid supportive structure configured for encasing at least partially said body part; and
a compression unit mounted on said supportive structure or on an element thereof, the compression unit is adapted for actuating intermittent pressure on said body part.

2. The apparatus of claim 1 wherein said compression unit, or at least a part thereof, is integrally formed on said supportive structure or element thereof.

3. The apparatus of claim 1 wherein said compression unit is detachably mounted on said supportive structure or element thereof.

4. The apparatus of claim 1 wherein said compression unit comprises at least one compression element and a mechanism coupled to said at least one compression element for actuating intermittent transitions of said element between a compression position and a relaxed position.

5. The apparatus of claim 4 wherein the actuator further includes a power source for supplying power to said mechanism.

6. The apparatus of claim 4 wherein said at least one compression element is a movable surface configured to be pressed against the body part and wherein said mechanism actuates a reciprocating motion of said movable surface in a direction substantially perpendicular to said surface.

7. The apparatus of claim 6 wherein the movable surface is a movable plate and wherein the mechanism actuates a reciprocating motion of the plate in a direction substantially perpendicular to the plate surface.

8. The apparatus of claim 4 wherein said at least one compression element is an inflatable bladder configured to be located juxtaposed to the body part and wherein said mechanism includes an air compressor for intermittently inflating said bladder.

9. The apparatus of claim 4 wherein said at least one compression element is a closure encircling at least partially said body part and wherein said mechanism actuates intermittent tightening of said closure around said body part.

10. The apparatus of claim 9 wherein said closure is a strap encircling the body part and wherein said mechanism intermittently pulls and releases at least one end of said strap for intermittently tightening said strap around said body part.

11. The apparatus of claim 9 wherein said closure comprises at least one flap partially encircling said body part and wherein said mechanism intermittently moves said at least one flap relatively to said body part for applying squeezing force on said body part.

12. The apparatus of claim 1 wherein said supportive structure is a cast construction made of moldable material.

13. The apparatus of claim 1 wherein said supportive structure is a prefabricated cast construction.

14. The apparatus of claim 1 wherein the supportive structure is a brace.

15. The apparatus of claim 1 wherein the compression unit is further provided with a control panel for allowing a user to set parameters of the compression unit operation.

16. A cast element adapted to be incorporated into a supportive structure for facilitating enhanced circulation in a body part supported by said supportive structure, the cast element comprising at least one compression unit adapted to actuate intermittent pressure on said body part.

17. The cast element of claim 16 wherein said at least one compression unit is an integral part of said cast element.

18. The cast construction of claim 16 wherein said compression unit is detachably mounted in an opening of said cast element.

19. A method for enhancing circulation in a body part in need of support, comprising:
supporting said body part by a supporting structure, said supporting structure is provided with an intermittent compression unit mounted thereon; and
activating said intermittent compression device to apply intermittent pressure on said body part.

20. The method of claim 19 wherein said supporting structure is provided with at least one opening for leaving at least one portion of said body part uncovered by the supporting structure and wherein said compression unit applies intermittent pressure by intermittently moving a movable surface in a reciprocating motion against said uncovered body portion.

21. The method of claim 20 wherein said movable surface is a compression plate.

22. The method of claim 20 wherein said movable surface is an inflatable bladder interposed between said body portion and a rigid surface.

23. The method of claim 20 wherein said compression unit comprises a closure for encircling at least partially the body part and wherein the compression unit applies intermittent pressure by intermittently tightening and releasing said closure.
